(19) United States
(12) Patent Application Publication
(10) Pub. No.: US 2006/0018322 A1
(43) Pub. Date: Jan. 26, 2006

(54) Dedicated service class for voice traffic

(76) Inventor: Moshe Oron, San Rafael, CA (US)

Correspondence Address: PILLSBURY WINTHROP SHAW PITTMAN LLP, P.O. BOX 10500, MCLEAN, VA, 22102, US

(21) Appl. No.: 10/897,305

(22) Filed: Jul. 21, 2004

(51) Int. Cl. H04L 12/56

(52) U.S. Cl. 370/395.1; 370/395.21

(57) ABSTRACT

An optical communication system according to one embodiment of the invention transmits traffic into an ATM network (e.g. a passive optical network) according to a per-class queuing scheme, wherein a separate CBR queue is dedicated to voice traffic.

### FIELD OF THE INVENTION

The invention relates to communication networks.

### BACKGROUND OF THE INVENTION

The following acronyms may appear in the description below: APON, asynchronous transfer mode (ATM) passive optical network (PON); ASIC, application-specific integrated circuit; ATM, asynchronous transfer mode; B-PON or BPON (broadband PON); CATV, community access television (cable television); CPU, central processing unit (e.g. microprocessor); EPON (Ethernet PON); FPGA, field-programmable gate array; ISDN, integrated services digital network; PON, passive optical network; POTS, plain old telephone service; PPV, pay per view; PSTN, public switched telephone network; RAM, random-access memory; ROM, read-only memory; TDM, time division multiplexed (or multiplexing); VoIP, voice over Internet Protocol; VoATM, voice over ATM; VoD, video on demand.

Optical access systems offer a potentially large bandwidth as compared to copper-based access systems. A broadband optical access system may be used, for example, to distribute a variety of broadband and narrowband communication services from a service provider's facility to a local distribution point and/or directly to the customer premises. These communication services may include telephone (e.g. POTS, VoIP, VoATM), data (e.g. ISDN, Ethernet), and/or video/audio (e.g. television, CATV, PPV, VoD) services.

FIG. 1 shows examples of two optical access network (OAN) architectures. The first example includes an optical line termination (OLT), an optical distribution network (ODN), an optical network unit (ONU), and a network termination (NT). The OLT provides the network-side interface of the OAN (e.g. a service node interface or SNI), and it may be located at a carrier's central office or connected to a central office via a fibre trunk (e.g. the OLT may include an OC-3/STM-1 or OC-12c/STM-4c interface).

The OLT may be implemented as a stand-alone unit or as a card in a backplane. The AccessMAX OLT card of Advanced Fibre Communications (Petaluma, Calif.) is one example of a superior OLT product. Other examples of OLTs include the 7340 line of OLTs of Alcatel (Paris, France), the FiberDrive OLT of Optical Solutions (Minneapolis, Minn.), and assemblies including the TK3721 EPON media access controller device of Teknovus, Inc. (Petaluma, Calif.). The OLT may communicate (e.g. via cable, bus, and/or data communications network (DCN)) with a management system or management entity, such as a network element operations system (NE-OpS), that manages the network and equipment.

On the user side, the OLT may be connected to one or more ODNs. An ODN provides one or more optical paths between an OLT and one or more ONUs. The ODN provides these paths over one or more optical fibres. The ODN may also include optional protection fibres (e.g. for backup in case of a break in a primary path).

An optical network unit (ONU) is connected to an ODN and provides (either directly or remotely) a user-side interface of the OAN. The ONU, which may serve as a subscriber terminal, may be located outside (e.g. on a utility pole) or inside a building. One or more network terminations (NTs) are connected to an ONU (e.g. via copper trace, wire, and/or cable) to provide user network interfaces (UNIs), e.g. for services such as Ethernet, video, and ATM. Implementations of such an architecture include arrangements commonly termed Fibre to the Building (FTTB), Fibre to the Curb (FTTC), and Fibre to the Cabinet (FTTCab).

The second architecture example in FIG. 1 includes an OLT, an ODN, and one or more optical network terminations (ONTs). An ONT is an implementation of an ONU that includes a user port function. The ONT serves to decouple the access network delivery mechanism from the distribution at the customer premises (e.g. a single-family house or a multi-dwelling unit or business establishment). Implementations of such an architecture include arrangements commonly termed Fibre to the Home (FTTH). In some applications, an ONT may be wall-mounted.

The AccessMAX ONT 610 of Advanced Fibre Communications (Petaluma, Calif.) is one example of a superior ONT product. Other examples of ONTs include the Exxtenz ONT of Carrier Access Corporation (Boulder, Colo.), the FiberPath 400 and 500 lines of ONTs of Optical Solutions, the 7340 line of ONTs of Alcatel, and assemblies including the TK3701 device of Teknovus, Inc.

As shown in FIG. 1, an OAN (including an ODU and the terminals connected to it) may be configured in several different ways, and two or more OANs may be connected to the same OLT. As shown in FIG. 2, an ODN may connect an OLT to multiple ONUs. An ODN may also be connected to both ONUs and ONTs. In some applications, the nominal bit rate of the OLT-to-ONU signal may be selected from the rates 155.52 Mbit/s and 622.08 Mbit/s, although other rates are also possible for upstream and downstream communications.

An ODN that contains only passive components (e.g. fibre and optical splitters and/or combiners) may also be referred to as a passive optical network (PON). Depending e.g. on the particular protocol used, a PON may also be referred to, for example, as a B-PON (broadband PON), EPON (Ethernet PON), or APON (ATM PON). A OAN may include different OLTs and/or ONUs to handle different types of services (e.g. data transport, telephony, video), and/or a single OLT or ONU may handle more than one type of service. The OLT and/or one or more of the ONUs may be provided with battery backup (e.g. an uninterruptible power supply (UPS)) in case of mains power failure.

FIG. 3 shows an example of a OLT connected to a PON that includes a four-way splitter 20 and four eight-way splitters 30a-d. In this example, each of up to thirty-two ONUs may be connected to the PON via a different output port of splitters 30a-d (where the small circles represent the PON nodes depending from these ports). Other PON configurations may include different splitter arrangements. In some such configurations, for example, a path between the OLT and one ONU may pass through a different number of splitters than a path between the OLT and another ONU.

The protocol for communications between the OLT and the ONUs may be ATM-based (e.g. such that the OLT and ONUs provide transparent ATM transport service between the SNI and the UNIs over the PON), for example. Such embodiments of the invention may be applied to optical access systems that comply with one or more of ITU-T Recommendation G.983.1 (“Broadband optical access systems based on Passive Optical Networks (PON),” dated October 1998 and as corrected July 1999 and March 2002 and amended November 2001 and March 2003, along with Implementor's Guide of October 2003) (International Telecommunication Union, Geneva, CH), and ITU-T Recommendation G.983.2 (“ONT management and control interface [OMCI] specification for B-PON,” dated June 2002 and as amended March 2003, along with Implementor's Guide of April 2000) (International Telecommunication Union, Geneva, CH). Additional aspects of optical access systems to which embodiments of the invention may be applied are described in the aforementioned Recommendations.

In a PON architecture, communications may be conducted according to a standardized technology known as Asynchronous Transfer Mode (ATM). Communication using ATM is accomplished through the switching and routing of fixed-size packets of data referred to as cells. Although ATM networks are often used to provide high speed Internet access, ATM technology and protocols also allow for the converged transmission of voice, data and video traffic simultaneously over high bandwidth circuits at speeds in the range between 1.5 Mbps to 2.5 Gbps.

The convergence of multiple service types across a single media may require adequate traffic management to ensure that the quality of service (QoS) of each of the communications services can be met. Maintaining the requisite level of quality of service generates specific constraints due to the fact that communications services have different characteristics. Voice services, for example, are typically very time-sensitive, in that the information should not be delayed excessively and the delay should not have significant variations. Distortion of the voice may drastically impact the quality and/or interactivity of the communication. However, voice services may be relatively insensitive to loss. By contrast, video is typically relatively insensitive to delay as compared to voice but may be more sensitive to delay variations and loss. As for data traffic, it is typically not sensitive to delay or delay variation but may be very sensitive to loss.

In order to support different communications service requirements and to properly control network congestion (which may be unavoidable), an ATM network may provide a communications service according to one of several different service categories. These service categories may include constant bit rate (CBR); variable bit rate (VBR), whether real-time (rt-VBR) or non-real-time (nrt-VBR); available bit rate (ABR); and unspecified bit rate (UBR). Traffic transferred according to a CBR or VBR category may be subject to a contract in which the network service provider guarantees a certain level of service. Traffic transferred according to a UBR category, on the other hand, may be given the network service provider's “best effort” only after the CBR and VBR traffic has been serviced.

Because voice services have the most stringent QoS requirements, they generally use CBR or rt-VBR categories. However, maintaining a requisite level of QoS for voice services remains a challenging endeavor. Even when voice traffic is serviced in CBR and/or rt-VBR categories, voice QoS can be affected by other, higher bandwidth, real-time services that traverse the same network using the same service category, such as digital video or circuit emulation of leased lines. Because the throughput of these services may exceed that of the voice traffic by an order of magnitude or more, in some cases they may consume the allocated network resources and crowd out the voice traffic. A resulting degradation of voice traffic quality may be manifested as longer delay, larger CDV, and in some cases higher Cell Loss Ratio (CLR).

### SUMMARY

An optical communication system according to an embodiment of the invention includes an ATM switching fabric; and an optical distribution network configured to distribute data received from the ATM switching fabric among a plurality of subscribers, wherein the ATM switching fabric is configured to provide a plurality of service classes, at least one of the plurality of service classes being a dedicated service class for voice services.

A method for transmitting data in an optical communication network according to an embodiment of the invention includes prioritizing data according to a plurality of service classes; and transmitting the data over an optical distribution network to a plurality of subscribers, wherein the plurality of service classes includes a dedicated service class for voice services.

### BRIEF DESCRIPTION OF THE DRAWINGS

FIG. 1 shows examples of two OAN architectures.

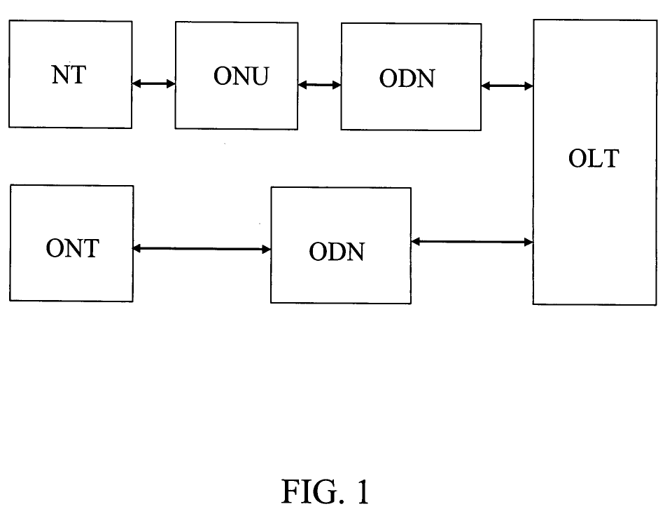

FIG. 2 shows an example of an OAN.

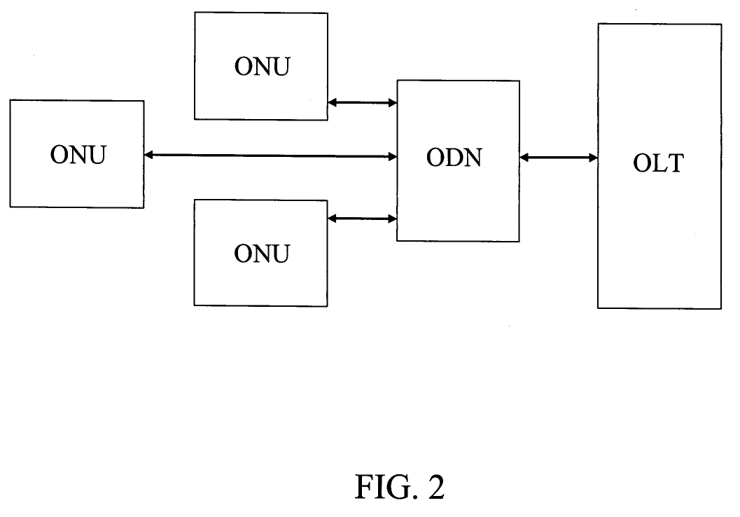

FIG. 3 shows an example of an OLT and a PON including splitters.

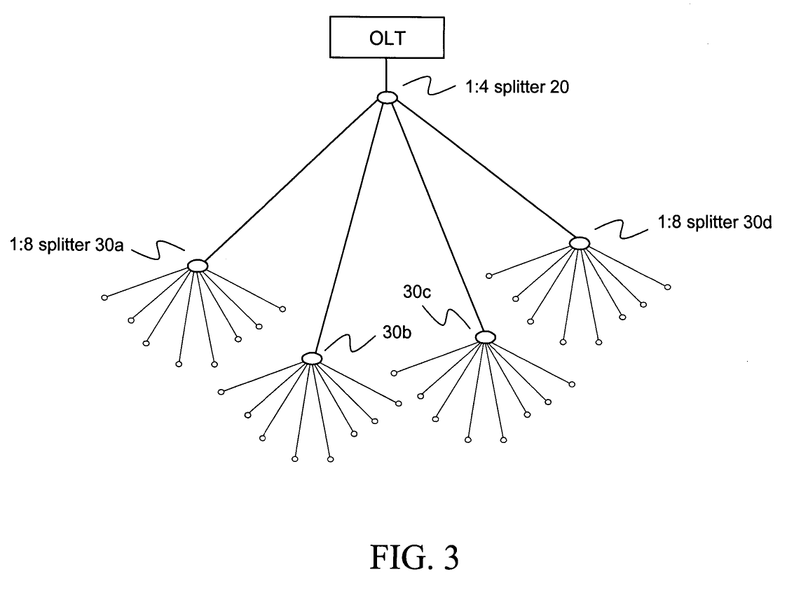

FIG. 4 is a schematic representation of a per-virtual circuit queuing scheme.

FIG. 5 is a schematic representation of a per-class priority queuing scheme.

FIG. 6 is a schematic representation of an access device according to an embodiment of the n.

FIG. 7 shows an example of a priority queuing scheme.

FIG. 8 is a schematic representation of a queue management unit according to an embodiment of the invention.

FIG. 9 is a schematic representation of an arbitration unit according to an embodiment of the invention.

FIG. 10 represents an assembly of traffic containers (T-CONTs) according to an embodiment of the invention.

FIG. 11 shows a system including a data storage medium according to an embodiment of the invention.

### DETAILED DESCRIPTION

One solution for larger CDV and higher CLR in voice traffic would be to use larger jitter buffers and deeper queues for voice traffic. If the queue is deeper, it is less likely that cells will be dropped off at the end of the queue. However, larger jitter buffers and queues may also increase delay. Although increased delay can be partially solved by echo cancellation, this technique remains costly and may not completely address certain large delay calls.

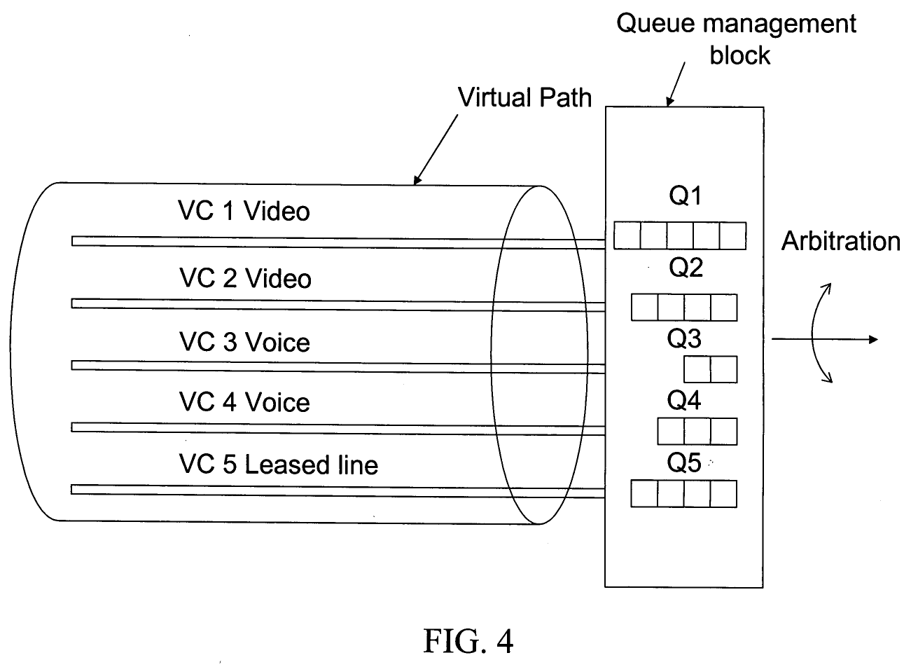

Another potential solution to address these issues would be to support dedicated queues and buffers for each virtual circuit (VC) associated with each type of information (video, voice, etc.). Since each communications service would be routed to a distinct queue, it would be possible to provide adequate service differentiation and QoS control for every service type. FIG. 4 shows one example of such a per-VC queuing configuration in which different types of traffic, which may be serviced under the same class (e.g. CBR in this example), are combined over a single virtual path. This virtual path includes virtual circuits VC1, VC2, VC3, VC4, and VC5 that are assigned to a first video traffic, a second video traffic, a first voice traffic, a second voice traffic, and a leased line, respectively. Each of these circuits is routed to a specific queue (Q1, Q2, Q3, Q4, and Q5, respectively) in a queue management block, which is configured to provide hierarchical or strict arbitration as between the different virtual circuits. Although a per-VC queuing model may provide adequate service differentiation, such a model remains costly, complex, and often impractical.

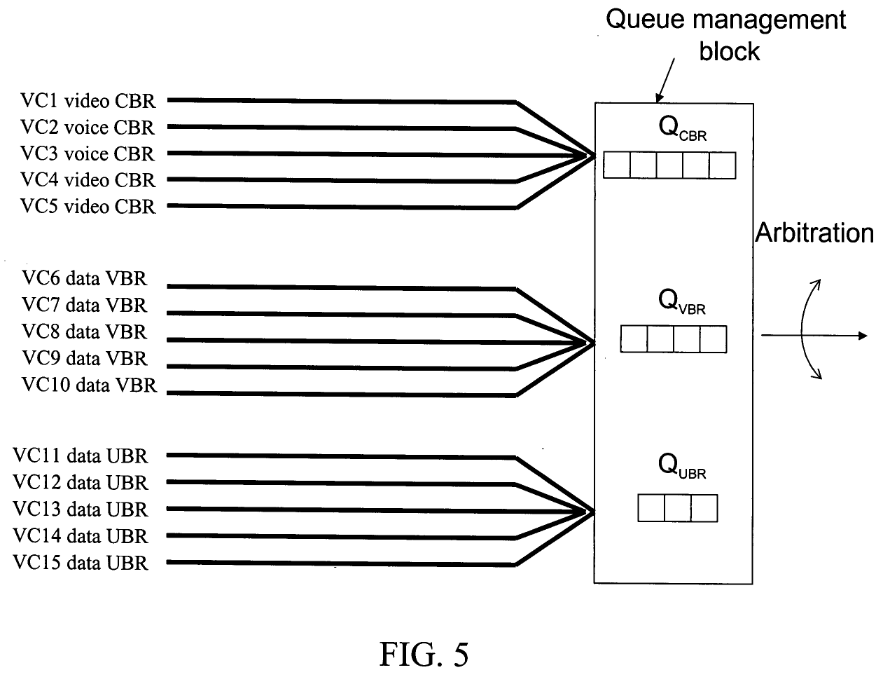

FIG. 5 shows an example of a priority queuing scheme. In this per-class queuing scheme, prioritization is done by service class, and a queue is assigned to a specific class of service in the queue management block. In this example, virtual circuits that belong to a particular class (CBR, VBR and UBR) are routed to a corresponding one of the dedicated queues (Queue_{CBR}, Queue_{VBR} and Queue_{UBR}). The arbitration unit may then provide strict arbitration as between the different service classes (e.g. with the CBR class being serviced first, the VBR class second and the UBR class last). In such a configuration, data which are serviced under the same service class (such as voice and video data under CBR) compete against each other.

Embodiments of the invention include an APON or BPON network that is configured to ensure high QoS for voice services. In one embodiment of the invention, the APON network is configured to support a dedicated voice service class (called VCE-CBR) which is assigned a higher priority than other classes of services, such as, for example, CBR, VBR, ABR and UBR. In other embodiments of the invention, a separate queue is provided for the VCE-CBR class at each queuing point. Such embodiments may also support hierarchical arbitration as between the service classes, with e.g. the VCE-CBR class being serviced first. These principles may be implemented such that voice services only compete against one another, and it may be possible to provide service differentiation sufficient to maintain voice quality without adding excessively to the cost and complexity of the overall system. In a PON, the VCE-CBR service class may be supported at, e.g., the OLT and ONUs.

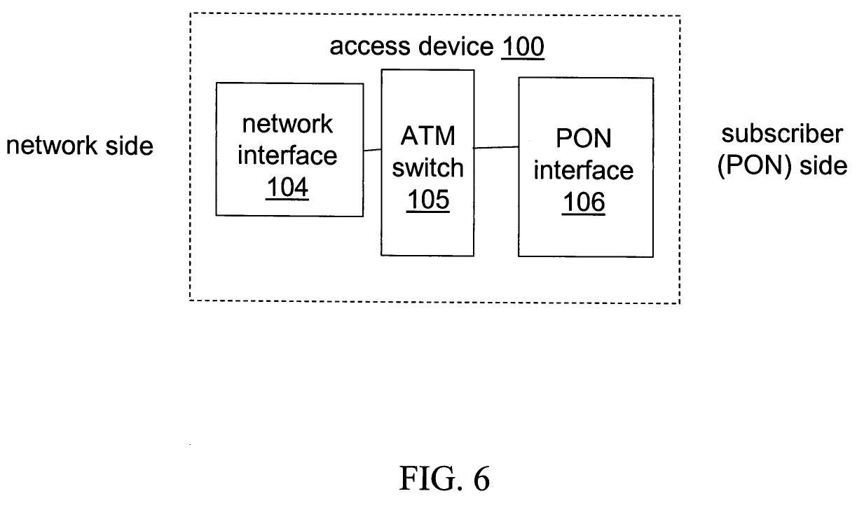

FIG. 6 is a schematic representation of an access device (OLT system) 101 according to an embodiment of the invention. Access device 101 may be coupled to a network such as the public or private ATM network 103 through a network interface 104. Access device 101 also includes an ATM switching fabric 105 and an PON interface 106 that may include, for example, hardware and/or software for providing virtual path, virtual channels or virtual circuits and cross connect functions. In some applications, PON interface 106 may be implemented as a card plugged into a backplane. Via one or more PONs, the access device is further in communication with ONTs and/or ONUs, which may include hardware and/or software for providing virtual channel terminations and virtual path cross connect functions, and may further include adaptation functions for interfacing with various other types of network interfaces such as Ethernet, for example. Each OLT PON interface may support up to about 64 ONUs. It will be appreciated that interfaces to additional PONs may be included in access device 1101. ATM switching fabric 105 may be configured to switch traffic to and from the various ONTs/ONUs and to enforce subscriber service contracts as indicated by an entity such as a network management system.

In an embodiment of the invention, the ATM switching fabric 105 is configured to support several service classes, which are classified according to specific attributes. The attributes of the service classes include bandwidth reservation, burstiness, delay sensitivity, CDV sensitivity and cell loss sensitivity. The burstiness is a commonly used measure of how constantly a source transmits traffic. A source that infrequently transmits traffic is deemed very bursty whereas a source that always sends data at the same rate is nonbursty. Table 1 summarizes an example of service classes supported by an access device or APON according to an embodiment of the invention.

TABLE 1

| PON service | | Bursti- | Delay | CDV | Cell Loss |
|---|---|---|---|---|---|
| class | Bandwidth | ness | Sensitivity | Sensitivity | Sensitivity |
| UBR | best effort | High | low | low | High |
| voice CBR | Guaranteed | Low | high | high | Low |
| (VCE-CBR) | | | | | |
| rt-VBR | Guaranteed | Low | medium | high | High |
| CBR | Guaranteed | Low | high | high | Medium |

In a guaranteed-bandwidth type of service, a bandwidth is entirely reserved and may be cyclically allocated in order to achieve a low cell transfer delay. Even if there is no data to be sent during a particular time period, cells containing idle traffic are sent for that period. By contrast, a “best effort” bandwidth indicates a bandwidth that is provided but there is no assurance or guarantee that such bandwidth will be available. In Table 1, voice communications have a dedicated service class such that all voice cells are serviced in the same class, i.e. the VCE-CBR class. Similarly to the traditional classes of service, the new VCE-CBR service class may be supported by the different components of the APON network.

Each of the service categories may be associated with parameters that describe a particular Quality of Service (QoS) and expected traffic characteristics. The traffic parameters may include parameters that specify the bandwidth guaranteed to the connection, such as the Peak Cell Rate (PCR) and Sustainable Cell Rate (SCR). The QoS parameters associated with a particular service category may include a specification of the acceptable cell loss rate (e.g., cell loss ratio, or “CLR”), and cell transfer delay characteristics (e.g., maximum cell transfer delay, or “CTD”). Using such parameters, a particular service category may support either real-time or non-real-time applications.

In operation, the incoming cell flow traffic from the network may be routed over a plurality of virtual circuits and virtual paths to a queue management unit of the ATM switching fabric. Each of these virtual circuits corresponds to a particular service, as shown in FIG. 4. When a virtual circuit is established, each end of the connection (e.g. the OLT and the corresponding ONU) is configured with the service class for the virtual circuit, e.g. in order to properly route it to a queue of the respective queue management unit. The queue management unit queues up the cells and arbitrates them according to a specific queuing scheme. The cells are then transmitted between the OLT and ONU over the optical distribution network. It will be appreciated that additional queuing points may be present in an APON. For example, a queue management unit can be present at each ONU of the network. Furthermore, it will be appreciated that there may be more than one queuing point (with a corresponding queue management unit) in the ONUs and/or in the OLT (e.g. at an ATM switch, at an interface card, etc.).

In order to ensure QoS for all services, traffic control mechanisms can help achieve the requisite parameters that define expected traffic characteristics. These control mechanisms may use queuing methods, in which cells are queued up into the memory buffers of network devices (e.g. routers and switches) in order to properly control traffic congestion. A queue management method can address or reduce traffic congestion by dropping cells when necessary or appropriate. For example, a best effort cell may be discarded to free up network resources (perhaps for the benefit of another virtual circuit or service class).

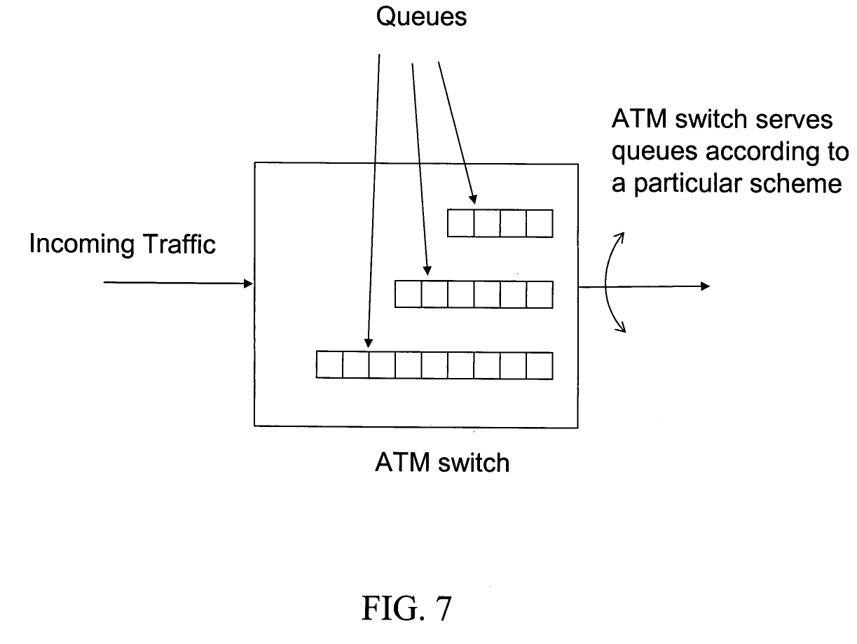

Queuing methods include FIFO queuing where cells are arranged in a first-in first-out order such that the first cell in the queue is the first cell that is processed. Another type of queuing method includes class-based queuing (CBQ) in which a certain transmission rate is guaranteed. In CBQ, the cell traffic is divided into classes based, for example, on a combination of addresses, application type or protocol. Another queuing method includes priority queuing. In this model, cells that are not tolerant of delay can jump ahead of those that are more tolerant of delay. This model uses multiple queues, which are serviced with different levels of priority, with the highest priority queues being serviced first. An example of a priority queuing scheme is given in FIG. 7. In this figure, the priority queuing function is performed in an output ATM buffered switch. Cells arriving in the output port are dispatched in different queues depending on the cells' level of priority. Then, the output port serves the queues according to their priority.

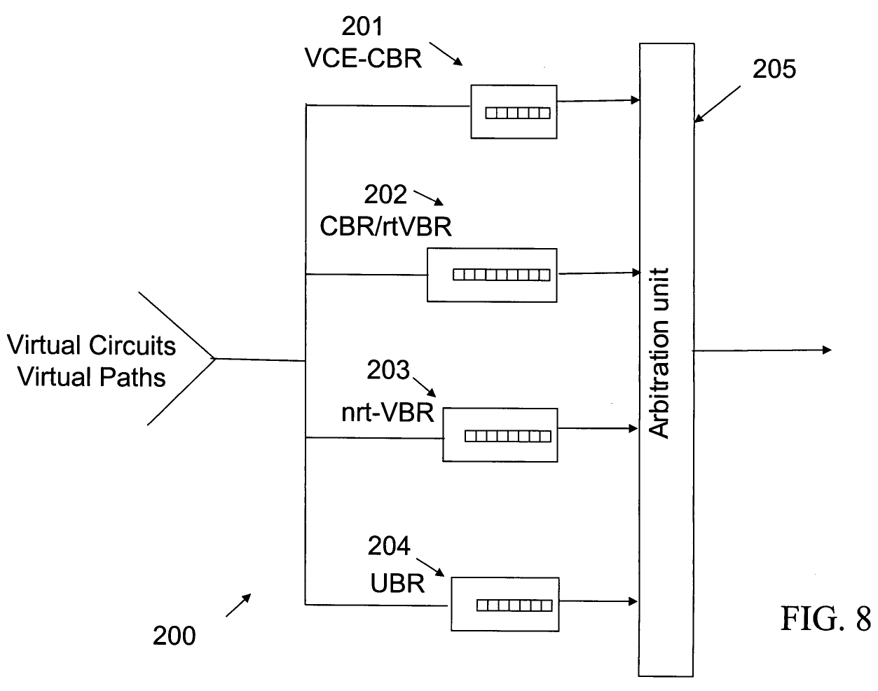

FIG. 8 is a schematic representation of a queue management unit 200 (e.g. of an ATM switching fabric) according to an embodiment of the invention. Queue management unit 200 is configured to control the cell traffic in order to achieve a range of QoS loss and delay parameters as may be required by the different service classes. In this example, queue management unit 200 includes a plurality of buffers that are configured as queues to store the incoming cells in accordance with their respective class of service. Such buffers may be implemented, for example, as separate semiconductor memory devices and/or as different portions of the same memory device. In the embodiment represented in FIG. 8, queue management unit 200 includes a dedicated voice-CBR queue 201. This particular example of a queue management unit 200 also includes a real-time service queue 202, which may be configured to queue up incoming cells serviced in CBR and rt-VBR classes, since for real-time service categories, cell transfer delay and cell delay variation are both important quality-of-service parameters. In other implementations, traffic transmitted according to CBR and rt-VBR service classes may be queued separately. Finally, this example of a queue management unit 200 includes a non-real-time VBR queue 203 and a UBR queue 204. Queue management unit 200 may be implemented, for example, as one or more integrated circuits (e.g. ASICs), FPGAs, or other hardware devices (e.g. network processors) and/or as one or more sets of instructions executing on one or more microprocessors or other arrays of logic elements.

With a separated queuing arrangement as shown in FIG. 8, isolation between voice services (e.g. VCE-CBR class) and other real-time services (CBR and rt-VBR) can be maintained. In some implementations, storage capacity of each buffer can be adjusted independently, e.g. such that the relative sizes of the queues can be set at any desired value (possibly dynamically). In that way, for example, it may be possible to optimize the queue size for the voice service without substantially affecting the remaining services. In at least some embodiments of the invention, the size of the queue for the voice service class can be very small relative to other service queues, due to the high priority and lower bandwidth requirement for voice traffic. As noted above, deeper queues may reduce loss but may also increase delay.

It may be desirable that a per-class queuing scheme is implemented, as shown in FIG. 8, to provide a single queue for each class (for example, for reduced complexity). However, in other applications it may be desired to combine a per-class queuing scheme with per-VC queuing for one or more of the classes, and a dedicated voice class as described herein may also be used in such applications. In such case, a queue management unit 200 may provide for one or more arbitration units configured to prioritize the cells among the various queues of the multi-queued class according to a predetermined scenario. Even in such a case, it may be desired not to provide multiple queues for the VCE-CBR service class, such that this service may be managed with minimal complexity.

Prioritization of the cells among the queues may be done according to different types of schemes, e.g. a FIFO scheme, a strict priority scheme, a round-robin or “fair” scheme (e.g. to ensure that low-priority schemes are serviced), or a weighted variation of such a scheme. The arbitration scheme may vary over time e.g. according to changing traffic conditions.

Such prioritization may be done with an arbitration unit 205, which is configured to regulate cell traffic stream between the access device 101 and the plurality of ONTs and ONUs (e.g. according to one or more arbitration schemes as mentioned above). For example, arbitration unit 205 may provide hierarchical or strict arbitration as between the different service categories (e.g. VCE-CBR, CBR/rt-VBR, nrt-VBR, and UBR), with the VCE-CBR services being serviced first, the CBR/rt-VBR second, the nrt-VBR third and the UBR last (i.e. according to a class-based queuing mode). In that way it may be possible to provide a high quality of service for voice communications while maintaining differentiations between the remaining traditional classes of service.

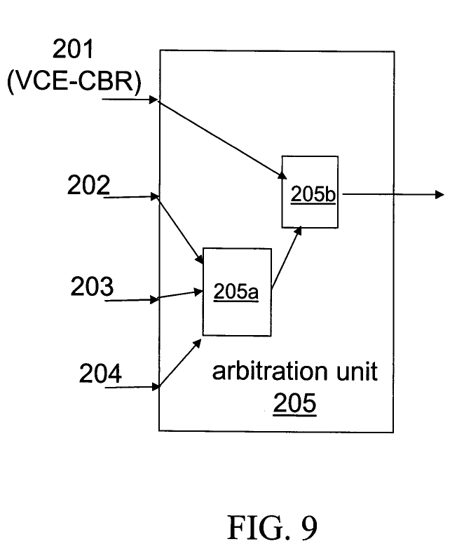

FIG. 9 shows an arbitration unit 205 according to another embodiment of the invention. In this example, arbitration unit 205 includes two class arbitration units 205a and 205b. The first class arbitration unit 205a is configured to provide arbitration as between the traditional classes of service (e.g. CBR/rt-VBR, nrt-VBR, and UBR) according to, for example, a weighted round-robin scheme. The second class arbitration unit 205b may then be used to arbitrate as between the VCE-CBR block and the cells transmitted by the first arbitration unit 205a (e.g. according to a strict or a weighted scheme).

It will be appreciated that a new voice-CBR service class as described herein may be implemented on downstream traffic (e.g. from OLT to ONU) and/or on upstream traffic (e.g. from ONU to OLT). Because certain CBR applications such as leased lines (e.g. T1) and video conferencing may be symmetrical in bandwidth, upstream voice traffic may also suffer competition for network resources as described herein. Furthermore, as the upstream traffic in a PON is typically restricted in bandwidth (e.g. four times less bandwidth) than the downstream traffic, in some cases the problem may even be worse for upstream voice traffic. Network architecture closer to the end user (e.g. at the ONT) may also be less distributed and/or differentiated than architecture at heavier traffic points, thus creating more opportunities for local resources to become temporarily monopolized by other services.

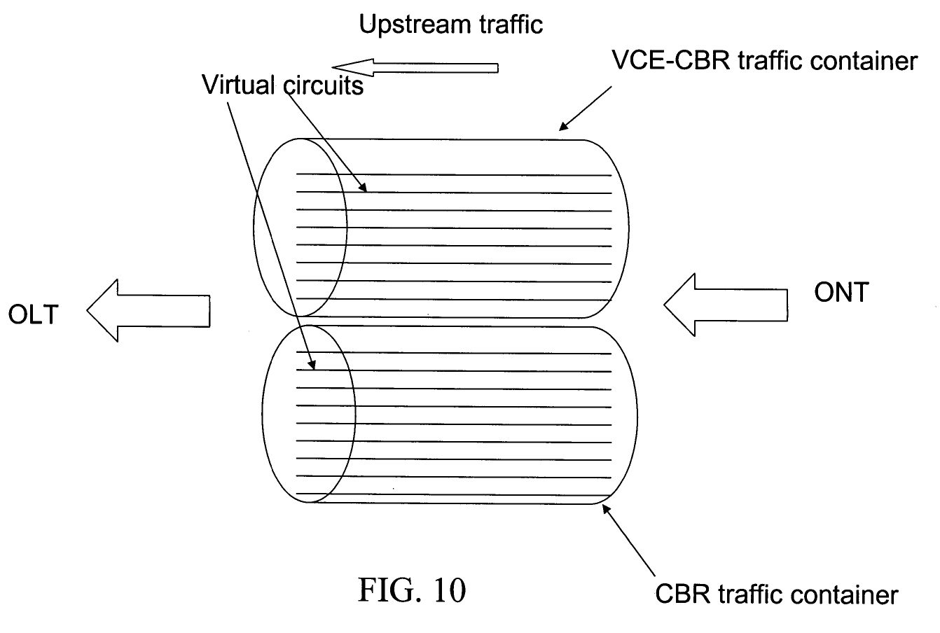

Upstream traffic on a PON may be routed, in an embodiment of the invention, via a unique arrangement of traffic containers (T-CONT). A T-CONT is a feature of the Dynamic Bandwidth Assignment (DBA) as specified by ITU-T G.983.4 (international Telecommunication Union, 2001). Multiple T-CONTs can be specified in one ONU/ONT. For example, the virtual channels and virtual paths from different classes may be grouped into several traffic containers (T-CONTS). ITU-T G.983.4 specifies five types of T-CONTs, which correspond to different service classes. T-CONT type 1 contains traffic sources corresponding to fixed bandwidths like CBR and rt-VBR, T-CONT type 2 can treat assured bandwidth, T-CONT type 3 covers assured bandwidth and non-assured bandwidth, T-CONT type 4 contains best-effort bandwidth, and T-CONT type 5 includes all types of bandwidth. In an embodiment of the invention, as shown in FIG. 10, the upstream voice service VCE-CBR may be allocated to a specific T-CONT, thereby ensuring the service differentiation between voice and other traffic. In this particular example, a T-CONT for voice services and a T-CONT for standard CBR service are shown. It will be appreciated that additional T-CONTs can be used in other embodiments of the invention (T-CONTs type 2, 3, 4, and 5).

It will be appreciated that embodiments of the invention may be applied as described herein such that voice communications only compete against each other. In such applications, the voice service is not affected by higher bandwidth services that may be carried under a similar class of service. Furthermore, it will be appreciated that such applications may avoid a need for per-virtual-circuit differentiation among voice communications, since voice traffic is typically of relatively very low bandwidth compared to other services. It is unlikely that voice traffic which is provided the highest priority for transport over an APON would suffer any significant delay or CDV due to other voice traffic.

It is expressly contemplated that alternative operations and/or configurations of such elements, and that apparatus including additional elements, are disclosed by and may be constructed according to the description provided herein. Embodiments of the invention may be applied at an OLT (e.g. to support downstream VCE-CBR), at an ONU (e.g. to support upstream VCE-CBR), or in both such devices connected via a PON.

The foregoing presentation of the described embodiments is provided to enable any person skilled in the art to make or use the present invention. While specific embodiments of the invention have been described above, it will be appreciated that the invention as claimed may be practiced otherwise than as described. Various modifications to these embodiments are possible, and the generic principles presented herein may be applied to other embodiments as well.

An embodiment of the invention may be implemented in part or in whole as a hard-wired circuit (e.g. implemented on a computer interface card) and/or as a circuit configuration fabricated into one or more arrays of logic elements arranged sequentially and/or combinatorially and possibly clocked (e.g. one or more integrated circuits (e.g. ASIC(s)) or FPGAs). Likewise, an embodiment of the invention may be implemented in part or in whole as a firmware program loaded or fabricated into non-volatile storage (such as read-only memory or flash memory) as machine-readable code, such code being instructions executable by an array of logic elements such as a microprocessor or other digital signal processing unit.

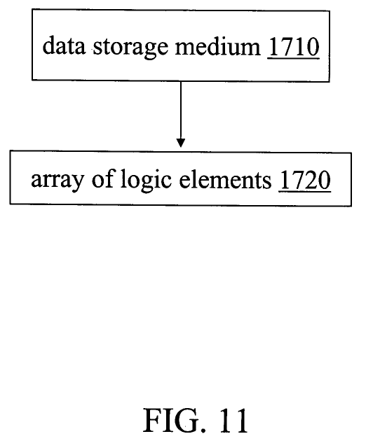

Further, an embodiment of the invention may be implemented in part or in whole as a software program loaded as machine-readable code from or into a data storage medium (e.g. as shown in FIG. 11) such as a magnetic, optical, magnetooptical, or phase-change disk or disk drive; or some form of a semiconductor memory such as ROM, RAM, or flash RAM, such code being instructions (e.g. one or more sequences) executable by an array of logic elements such as a microprocessor or other digital signal processing unit, which may be embedded into a larger device. Thus, the present invention is not intended to be limited to the embodiments shown above but rather is to be accorded the widest scope consistent with the principles and novel features disclosed in any fashion herein.

What is claimed is:

1. An optical communication system comprising:
an ATM switching fabric; and
an optical distribution network configured to distribute data received from the ATM switching fabric among a plurality of subscribers,
wherein the ATM switching fabric is configured to provide a plurality of service classes, at least one of said plurality of service classes being a dedicated service class for voice services.

2. An optical communication system according to claim 1, wherein the dedicated service class for voice services is a Constant Bit Rate service class.

3. An optical communication system according to claim 1, wherein the ATM switching fabric includes a queue management unit configured to queue up data according to their service class.

4. An optical communication system according to claim 3, wherein the queue management unit includes a plurality of buffers, at least one said plurality of buffers being a dedicated buffer configured to store data for voice services.

5. An optical communication system according to claim 4, wherein queues in said dedicated buffer can be adjusted independently from the queues in the remaining of the plurality of buffers.

6. An optical communication system according to claim 1, wherein the ATM switching fabric includes an arbitration unit configured to prioritize data according to their service class before transmitting them to the optical distribution network.

7. An optical communication system according to claim 6, wherein voice data of the dedicated voice service class have the highest priority.

8. An optical communication system according to claim 1, wherein the dedicated service class for voice services is implemented in downstream and upstream traffics.

9. A system configured to transfer data, said system comprising:
a plurality of queues, each queue dedicated to traffic of at least one corresponding service class;
a switch configured to receive traffic and to distribute the received traffic among the plurality of queues according to the corresponding service classes; and
an arbitrator configured to transport cells from the plurality of queues into an ATM network according to an arbitration scheme,
wherein the first queue is dedicated to voice traffic, and
wherein the switch is configured to direct additional traffic different than the voice traffic into a second queue dedicated to a Constant Bit Rate service class.

10. The system according to claim 9, wherein at least one of the plurality of queues comprises more than one queue.

11. The system according to claim 9, wherein the arbitrator is configured to transport cells into a passive optical network.

12. The system according to claim 9, wherein the first queue has the highest priority among the plurality of queues in the arbitration scheme.

13. The system according to claim 9, wherein the additional traffic includes at least one of video and T1 line emulation.

14. The system according to claim 9, wherein the first queue is dedicated to a Constant Bit Rate service class.

15. The system according to claim 9, wherein the system is configured to transmit the voice traffic into the ATM network using at least one traffic container.

16. The system according to claim 9, wherein the plurality of queues includes at least one among the group consisting of a queue dedicated to a Variable Bit Rate service class and a queue dedicated to an Unspecified Bit Rate service class.

17. The system according to claim 9, wherein the second queue is dedicated to a Variable Bit Rate service class.

18. The system according to claim 9, wherein the switch is configured to direct voice traffic from a plurality of different voice channels into the first queue.

19. The system according to claim 9, wherein the system comprises a plurality of voice ports, and wherein the switch is configured to direct traffic from the voice ports into the first queue.

20. The system according to claim 9, wherein the system is configured to receive traffic from a plurality of channels of a time-division-multiplexed circuit, and wherein the switch is configured to direct traffic from the plurality of channels into the first queue.

21. The system according to claim 9, wherein said system comprises:
an optical line termination (OLT) that includes said plurality of queues, said switch, and said arbitrator;
an optical networking unit (ONU) configured to receive voice traffic from said OLT; and
a passive optical network (PON) configured to carry said voice traffic directly from said OLT to said ONU.

22. The system according to claim 21, wherein said OLT is configured to transfer traffic according to a per-class queuing scheme.

23. The system according to claim 9, wherein said system comprises:
an optical networking unit (ONU) that includes said plurality of queues, said switch, and said arbitrator;
an optical line termination (OLT) configured to receive voice traffic from said ONU; and
a passive optical network (PON) configured to carry said voice traffic directly from said ONU to said OLT.

24. The system according to claim 23, wherein said ONU is configured to transfer traffic according to a per-class queuing scheme.

25. The system according to claim 23, wherein said ONU includes a plurality of telephony ports, and
wherein said first queue is configured to receive voice traffic based on signals received via at least one of said plurality of voice ports.

26. A method for transmitting data in an optical communication network comprising:
prioritizing data according to a plurality of service classes; and
transmitting said data over an optical distribution network to a plurality of subscribers,
wherein said plurality of service classes includes a dedicated service class for voice services.

27. A method according to claim 26, wherein the service class for voice services has the highest transmission priority.

28. A method of communications, said method comprising:
receiving voice traffic from a plurality of different voice channels;
transmitting the voice traffic into an asynchronous transfer mode (ATM) network over a first virtual circuit;
receiving additional traffic different than the voice traffic; and
transmitting the additional traffic into the ATM network over a second virtual circuit according to a Constant Bit Rate service class.

29. The method of communications according to claim 28, wherein each of the plurality of different voice channels corresponds to one of a plurality of voice ports of an optical networking termination.

30. The method of communications according to claim 28, wherein said receiving voice traffic includes receiving voice traffic from a plurality of channels of a time-division-multiplexed (TDM) circuit.

31. The method of communications according to claim 28, wherein said transmitting the voice traffic includes transmitting the voice traffic into a passive optical network.

32. The method of communications according to claim 28, wherein said transmitting the voice traffic includes directing the voice traffic to a first queue having a first priority, and wherein said transmitting the additional traffic includes directing the additional traffic to a second queue having a second priority lower than the first priority.

33. The method of communications according to claim 28, wherein said transmitting voice traffic includes transmitting the voice traffic into the ATM network according to a Constant Bit Rate service class.

34. The method of communications according to claim 28, wherein the additional traffic includes at least one of video and T1 line emulation.

35. The method of communications according to claim 28, wherein said transmitting the voice traffic includes transmitting the voice traffic using at least one traffic container.

36. The method of communications according to claim 28, said method comprising transmitting further additional traffic into the ATM network according to at least one among the group consisting of a Variable Bit Rate service class and an Unspecified Bit Rate service class.

37. The method of communications according to claim 28, said method comprising transmitting traffic over the second virtual circuit according to a Variable Bit Rate service class.

38. The method of communications according to claim 28, wherein each of the plurality of different voice channels corresponds to one of a plurality of telephony ports of an optical networking termination (ONT), and
wherein said transmitting the voice traffic includes transmitting the voice traffic to an optical line termination (OLT) via a passive optical network that terminates at the ONT and at the OLT.

39. The method of communications according to claim 38, wherein said transmitting the voice traffic includes switching the voice traffic onto a first queue of the ONT according to a per-class queuing scheme, and
wherein said transmitting the additional traffic includes switching the additional traffic onto a second queue of the ONT according to the per-class queuing scheme.

40. The method of communications according to claim 28, wherein each of the plurality of different voice channels corresponds to one of a plurality of time-division-multiplexed (TDM) channels terminating at an optical line termination (OLT), and
wherein said transmitting the voice traffic includes transmitting the voice traffic to an optical networking termination (ONT) via a passive optical network that terminates at the OLT and at the ONT.

41. The method of communications according to claim 40, wherein said transmitting the voice traffic includes switching the voice traffic onto a first queue of the OLT according to a per-class queuing scheme, and
wherein said transmitting the additional traffic includes switching the additional traffic onto a second queue of the OLT according to the per-class queuing scheme.

42. A data storage medium storing at least one set of machine-readable instructions, said instructions describing a method of communications, said method comprising:
receiving voice traffic from a plurality of different voice channels;
transmitting the voice traffic into an asynchronous transfer mode (ATM) network over a first virtual circuit;
receiving additional traffic different than the voice traffic; and
transmitting the additional traffic into the ATM network over a second virtual circuit according to a Constant Bit Rate service class.
